(19) United States
(12) Patent Application Publication
(10) Pub. No.: US 2025/0335786 A1
(43) Pub. Date: Oct. 30, 2025

(54) UNSUPERVISED DETERMINATION OF SIMILAR CHUNKS OF TEXT TO TUNE A TEXT SIMILARITY MODEL

(71) Applicant: Oracle International Corporation, Redwood Shores, CA (US)

(72) Inventor: Liviu Matei, Bucharest (RO)

(73) Assignee: Oracle International Corporation, Redwood Shores, CA (US)

(21) Appl. No.: 18/646,057

(22) Filed: Apr. 25, 2024

(30) Foreign Application Priority Data
Apr. 25, 2024 (RO) A/10013/2024

(51) Int. Cl. G06N 5/01; G06F 16/33

(52) U.S. Cl. CPC G06N 5/01; G06F 16/3344

(57) ABSTRACT

Systems, media, and computer-implemented methods are provided for identifying similar chunks of text to tune a text similarity model, such as a text similarity model that is used to find content in response to queries. Using a masked language model, a machine learning model may be tuned on different content from that which the machine learning model was trained. The machine learning model as tuned may be used to determine vector embeddings for terms in chunks of content. Chunks may be matched to each other by finding a term in one chunk having a highest similarity score with a corresponding term in another chunk. Aggregate similarity scores may be determined between the chunks based on the term-to-term similarity scores. If an aggregate similarity score for a pair of chunks satisfies one or more conditions, a text similarity model may be tuned to identify the pair as similar.

### CROSS REFERENCE OF RELATED APPLICATIONS

This application claims priority to Romanian Patent Application with Registration No. A/10013/2024, Attorney Docket No. 22/2024, Inventor Liviu Matei, filed on Apr. 25, 2024, titled “Unsupervised Determination of Similar Chunks of Text to Tune Similarity Model”, which is incorporated by reference in its entirety for all purposes.

### BACKGROUND

Machine learning is used in many software tools to help the software tools make better decisions, perform additional tasks that were previously not possible, and make connections that even the most intelligent humans cannot make without use of the software tools.

Machine learning models may be trained on data sets that are of sizes that are effectively incomprehensible as data sets without use of the software tools. The data sets may be complex have a wide range of variations and ambiguities that different humans would view differently. Machine learning models are capable of consuming these large data sets and making connections, correlations, and detecting patterns that were never before possible to make or detect.

A sentence-based machine learning model may be trained to detect similar sentences by providing pairs of sentences that have been manually determined to be similar or dissimilar, based on the judgment of expert manual users. This task can be challenging due to the lack of similar sentences, but the sentence-based model performs well with a sufficiently large labeled data set such as one containing tens or hundreds of thousands or millions of pairs of sentences that are marked by experts as similar or dissimilar.

Machine learning models are only as good as the data on which they are trained. If a sentence-based model has been trained on only a few hundred pairs of sentences, for example, the sentence-based model will have a difficult time accurately determining text that is similar to input text.

### BRIEF SUMMARY

In some embodiments, systems, media, and computer-implemented methods are provided for identifying similar chunks of text to tune a text similarity model, such as a text similarity model that is used to find content in response to queries. Using a masked language model, a machine learning model may be tuned on different content from that which the machine learning model was trained. The machine learning model as tuned may be used to determine vector embeddings for terms in chunks of content. Chunks may be matched to each other by finding a term in one chunk having a highest similarity score with a corresponding term in another chunk. Aggregate similarity scores may be determined between the chunks based on the term-to-term similarity scores. If an aggregate similarity score for a pair of chunks satisfies one or more conditions, a text similarity model may be tuned to identify the pair as similar.

In one embodiment, a computer-implemented method includes using a masked language model to tune a machine learning model on a corpus of content different than another corpus of content on which the machine learning model was previously trained. Using the masked language model to tune the machine learning model causes additional terms to be added to a dictionary of the machine learning model, and the corpus of content includes the additional terms. The computer-implemented method further includes using the machine learning model as tuned to determine a plurality of vector embeddings for a plurality of terms in a plurality of chunks of content from a particular corpus of content that is different than the other corpus of content on which the machine learning model was previously trained. The plurality of chunks of content comprises a first chunk, a second chunk, and a third chunk. The first chunk comprises a first plurality of terms. The second chunk comprises a second plurality of terms. The third chunk comprises a third plurality of terms. The computer-implemented method further includes determining a first vector embedding for a first term having a highest similarity score, among the second plurality of terms, with a particular vector embedding of a particular term of the first plurality of terms. The computer-implemented method further includes determining a second vector embedding for a second term having a highest similarity score, among the third plurality of terms, with the particular vector embedding of the particular term of the first plurality of terms. The computer-implemented method further includes determining a third vector embedding for a third term having a highest similarity score, among the second plurality of terms, with another particular vector embedding of another particular term of the first plurality of terms. The computer-implemented method further includes determining a fourth vector embedding for a fourth term having a highest similarity score, among the third plurality of terms, with the other particular vector embedding of the other particular term of the first plurality of terms. A first aggregate similarity score is determined between the first chunk and the second chunk based at least in part on similarity scores between the particular term and the first term, and the other particular term and the third term. A second aggregate similarity score is determined between the the first chunk and the third chunk based at least in part on similarity scores between the particular term and the second term, and the other particular term and the fourth term. Based at least in part on determining that the first aggregate similarity score satisfies one or more conditions, the computer-implemented method stores an indication that the first chunk is similar to the second chunk; wherein the second aggregate similarity score does not satisfy the one or more conditions. The computer-implemented method further includes tuning a text similarity model to identify similar texts by providing, to the text similarity model, the indication. In an embodiment, the text similarity model is used to identify content in response to a query.

In a further embodiment, using the masked language model to tune the machine learning model includes masking terms in the other corpus of content, receiving predictions of the machine learning model for the masked terms, and providing feedback to the machine learning model on accuracies of the predictions.

In the same or a different further embodiment, a first similarity score between the first vector embedding and the particular vector embedding, a second similarity score between the second vector embedding and the particular vector embedding, a third similarity score between the third vector embedding and the other particular vector embedding, and a fourth similarity score between the fourth vector embedding and the other particular vector embedding are each determined based at least in part on cosine similarity.

In the same or a different embodiment, the machine learning model includes a Bidirectional Encoder Representations from Transforms (BERT)-based uncased token-based model.

In the same or a different embodiment, the other corpus of content consists of publicly available text sources, and wherein the corpus of content comprises domain-specific text sources from an access-restricted private database.

In the same or a different embodiment, determining the first aggregate similarity score between the first chunk and the second chunk comprises averaging similarity scores between terms in the first chunk and terms in the second chunk. In this embodiment, determining the second aggregate similarity score between the first chunk and the third chunk includes averaging similarity scores between terms in the first chunk and terms in the third chunk.

In the same or a different embodiment, the computer-implemented method further includes accessing an index of similar chunks to determine that the second chunk is similar to a fourth chunk. Based at least in part on the index, the computer-implemented method may store another indication that the first chunk is similar to the fourth chunk, and tune the text similarity model to identify similar texts by providing, to the text similarity model, the other indication.

In the same or a different embodiment, the one or more conditions comprise a similarity threshold, and wherein the text similarity model is not tuned with an indication that the first chunk is similar to the third chunk. In an alternative embodiment, the one or more conditions comprise a similarity threshold, and the computer-implemented method further includes, based at least in part on determining that the second aggregate similarity score satisfies one or more other conditions, storing another indication that the first chunk is dissimilar to the third chunk. In this embodiment, the first aggregate similarity score does not satisfy the one or more other conditions, and the text similarity model is tuned to identify dissimilar texts by providing, to the text similarity model, the other indication.

In the same or a different embodiment, the query is a natural language query, and the computer-implemented method further includes receiving the query via a user interface. In this embodiment, using the text similarity model to identify content in response to the query may include using the text similarity model, and ranking two or more candidate results of a plurality of candidate results to the query based on how similar text in the two or more candidate results are to the query. Based at least in part on the ranking, the computer-implemented method causes display of a reference to at least one of the two or more candidate results of the plurality of candidate results to the query.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart depicting an example process for determining similar chunks of text to tune a text similarity model without relying on expert-provided labels.

FIGS. 2A and 2B illustrate a system diagram depicting example systems for determining similar chunks of text to tune a text similarity model without relying on expert-provided labels.

FIG. 3 illustrates a diagram of an example user interface for displaying search results that match chunks of text similar to a query.

FIG. 4 depicts a simplified diagram of a distributed system for implementing certain aspects.

FIG. 5 is a simplified block diagram of one or more components of a system environment by which services provided by one or more components of an embodiment system may be offered as cloud services, in accordance with certain aspects.

FIG. 6 illustrates an example computer system that may be used to implement certain aspects.

### DETAILED DESCRIPTION

Techniques are described herein for identifying similar chunks of text to tune a text similarity model, such as a text similarity model that is used to find content in response to queries. A masked language model may be used to tune a machine learning model on different content from that which the machine learning model was trained. The machine learning model as tuned may be used to determine vector embeddings for terms in chunks of content, such as paragraphs, sentences, social media posts, blog posts, articles, and/or queries. Chunks may be matched to each other by finding a term in one chunk having a highest similarity score with a corresponding term in another chunk. Aggregate similarity scores may be determined between the chunks based on the term-to-term similarity scores. If an aggregate similarity score for a pair of chunks satisfies one or more conditions, a text similarity model may be tuned to identify the pair as similar. In various embodiments, the techniques are implemented using non-transitory computer-readable storage media to store instructions which, when executed by one or more processors of a computer system, cause models to be stored, data structures to be updated, and/or information to be displayed. The techniques may be implemented on a local or cloud-based computer system that includes processors and a display for showing the user interface to a user for configuring models and/or viewing results from configured models. The computer system may communicate with client computer systems for displaying similar text resulting from model evaluation.

A description of identifying similar chunks of text to tune a text similarity model is provided in the following sections:
TOKEN-BASED MODEL OF TEXT DATA.
MASKED LANGUAGE MODEL OF DOMAIN-SPECIFIC CONTENT
DETERMINING CHUNK-TO-CHUNK SIMILARITY BASED ON TOKEN-TO-TOKEN SIMILARITY FOR DOMAIN-SPECIFIC CHUNKS OF TEXT.
TRAINING A TEXT SIMILARITY MODEL BASED ON THE CHUNK-TO-CHUNK SIMILARITY
USING THE TEXT SIMILARITY MODEL TO DETERMINE A SIMILARITY BETWEEN CHUNKS OF TEXT
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Various techniques are described herein with reference to paragraphs, sentences, social media posts, blog posts, articles, queries, and/or other chunks of text. Any such techniques can be applied to any one or a combination of texts from this example list or from other texts not included on this list. Example models created for certain chunks of text may also be applied to other chunks of text. For example, a paragraph model may be applied to queries, sentences, or social media posts, and the paragraph model will still operate to detect similar texts.

### Token-Based Model of Text Data

In an unsupervised system, the models may learn from examples and using techniques that do not require expert review, while training a sentence model on domain-specific content or other body of content.

In one embodiment, a single-word or other token-based model may be pre-trained on a general corpus of data, for example, text from Wikipedia®, web sources, or some other available body of text content. For example, a Bidirectional Encoder Representations from Transforms (BERT)-based-uncased or BERT-based-multilingual-uncased token-based model may be trained on the general corpus of data. BERT-based models apply a bidirectional training of Transformer, an attention model, to language modeling. BERT-based models use encodings in both directions away from a token to better understand the token in the context of the surrounding text in a sentence, paragraph, or other chunk of text. By using encodings that account for the other words in the sentence, BERT-based models provide insight into an intended meaning of a word as used in the text.

BERT-based models create vector embeddings for each token in an array of tokens. As described herein, vector embeddings may include numerical or otherwise deterministically comparable values, such as values combined in a vector form, that describe content, such as a token in the case of a token or word embedding or a sentence or paragraph in the case of a sentence or paragraph embedding. The vector embeddings for each token may include, for example, word embeddings using WordPiece or another topology map to convert words into representative numbers that can be marked as present. The vector embeddings may also include position embeddings to provide a position within a window of up to, for example, 512 words. The vector embeddings may also include token embeddings that mark tokens that are literally present in the text. The BERT-based models then use Transformer encoders to perform transformations over the array of vectors that represent the array of tokens, to generate a transformed array of vectors. The transformations account for prior tokens and following tokens in the chunk of text. The transformed array of vectors is unembedded into an array of tokens again with the proper semantic meaning and context applied to each token. For example, the sentence “I am driving a Jaguar” and “There is a Jaguar at the zoo” may start with the same token embedding for the word “Jaguar,” but after the transformations that account for the preceding word “driving” in one sentence and following word “zoo” in another sentence, the embedding for the word “Jaguar” would be different for the two sentences. One sentence would have “Jaguar” embedded as a subset of “vehicle,” and another sentence would have “Jaguar” as embedded a subset of “animal”.

BERT models may be pre-trained to learn the resulting array of tokens that represents the meaning of words in light of their surrounding contexts. During pre-training, BERT models may be improved using a variety of unsupervised pre-training tasks. For example, the BERT-based models may use a base masked language model to improve training of the model on the general corpus of data. For a portion of the general corpus of data, the base masked language model masks words and adjusts the BERT-based model to better predict the masked words. The adjustments may be made using an added layer on top of the learning system to make guesses. The BERT-based model is checked to see how well the model predicts words, and the layer is modified based on the results to better predict the missing word and a probability or confidence of which word is the missing word. Each layer may output an updated better understanding of the semantic meaning of the tokens as either a transformed array of vectors or an array of tokens, any of which can be further consumed and transformed by a subsequent layer.

As another example, BERT-based models may also be trained to predict sentences by being given two chunks of text and predicting whether the two chunks of text appeared sequentially in a portion of the general corpus of data. The model is adjusted to better predict whether a sentence occurs next in sequence or not. As yet another example, BERT-based models may be trained to understand the relationship between two sentences and be adjusted to better predict the relationship. These adjustments may also be implemented in layers added to the predicted meaning of a word to better align with the word's context in a sentence, among sentences, and accounting for word and sentence ordering. The layers are based on probabilities of a word having a specific meaning in a sentence, among sentences, and accounting for word and sentence ordering.

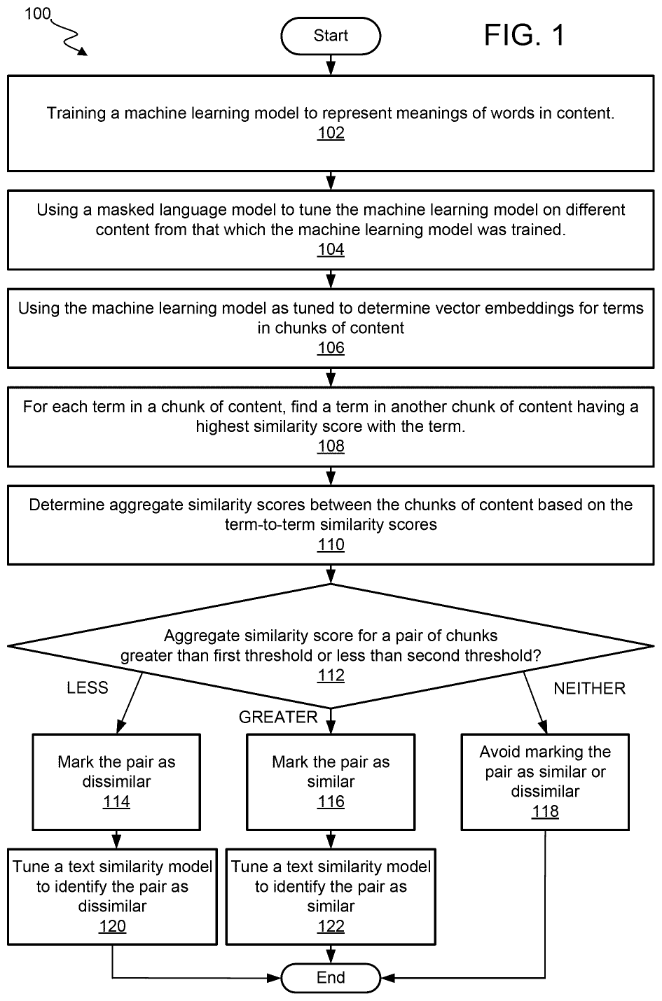

FIG. 1 illustrates a flow chart depicting an example process 100 for determining similar chunks of text to tune a text similarity model without relying on expert-provided labels. The process begins in block 102, where a machine learning model is trained to represent meanings of words in content. The machine learning model may be tuned on domain-specific content and used for determining term-to-term similarity and, in turn, chunk-to-chunk similarity for tuning a text similarity model.

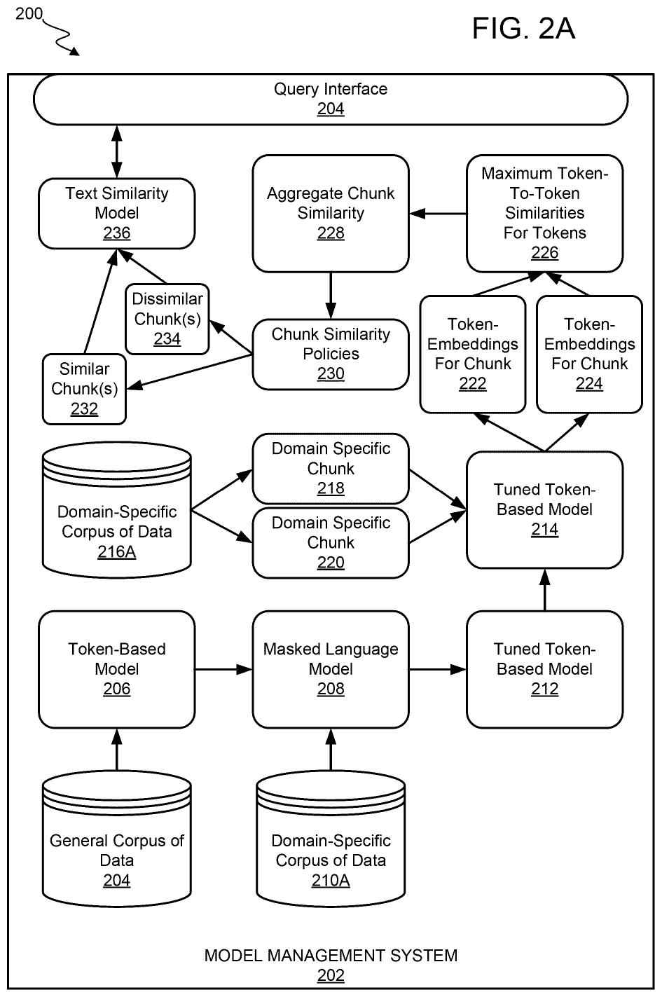

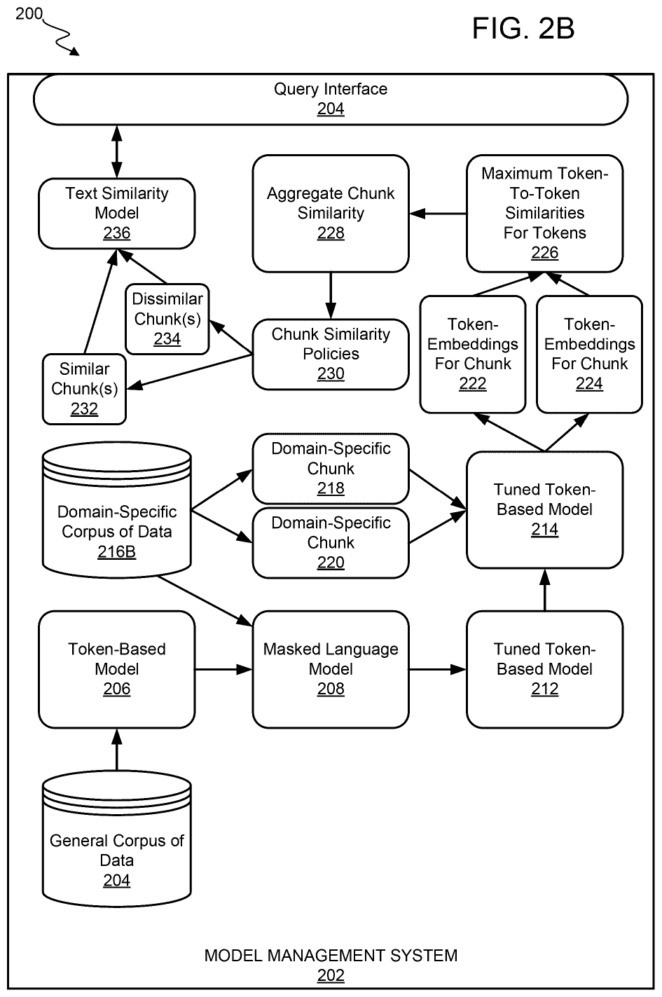

FIGS. 2A and 2B illustrate a system diagram depicting example systems for determining similar chunks of text to tune a text similarity model without relying on expert-provided labels. As shown, token-based model 206 is trained on a general corpus of data 204. Token-based model 206 may then be used in model management system 202 of computer system 200 for determining similar text in response to a query received via query interface 204.

### Masked Language Model of Domain-Specific Content

Masked language models (MLMs) are unsupervised models that mask terms and train or tune a model to better detect the masked terms. MLMs are unsupervised in the sense that the masking is performed on a full dataset, and the feedback or tuning is provided based on an unmasked version of the full dataset. MLMs may improve performance of some models. However, when used directly to train a pre-trained sentence model, MLMs decrease the performance of the sentence model. For this reason, masked language models are generally not applied to pre-trained sentence models. Instead, paraphrase training using supervised feedback or labels about similar phrases as determined by experts (e.g., from manually annotated/tagged datasets) can be used to train sentence models. Unfortunately, supervised feedback comes at a cost that is not scalable and not efficient for new sets of domain-specific content. Some systems may rely on clickstream data to supplement expert feedback, but similar sentences are difficult to extract from clickstream data, which relies on clicks from searches rather than a true similarity between the query and the document. A search query may not be similar to the title of a result or snippet even if the result or snippet is selected by the user, for example, for other reasons. The result or snippet may even be unrelated but otherwise interesting to users.

In a supervised system, the models may be given positive and negative examples, or example pairs of text determined by an expert to be similar (positive similarity) or dissimilar (negative similarity), and the models may learn from these examples to score other pairs of text as similar or dissimilar.

Major large language model (LLM) providers such as OpenAI, Cohere, and others offer services to generate embeddings for paragraphs/sentences. After the representation of the document as an embedding, the document can be stored in different vector DBs which can be later on queried in order to determine similar documents. A key problem that appears is represented by the custom or domain-specific language which requires fine tuning on a specific dataset. Fine tuning on similar sentences can be very difficult using paraphrase training, which requires a lot of manually annotated data.

In one embodiment, after the token-based model is pre-trained on the general corpus of data, a masked language model (MLM) may then be used to tune the pre-trained model on domain-specific content or other custom content, such that the embeddings for each word or other token in the model account for the new, different, or shifted terminology in the custom content. For example, the domain-specific content may be private, access-restricted, or non-published or otherwise distinct from the general corpus of data that was used to pre-train the token-based model. In a specific example, aerospace engineering content may include terminology that was not referenced in the general corpus of data that was used to pre-train the token-based model (e.g., camber for the convexity of curve of an aircraft wing, aeroelasticity for the interaction between inertial, elastic, and aerodynamic forces, aileron for a hinged flight control surface, or empennage for the tail or tail assembly), and/or may use terminology in a different way (e.g., nose of a plane versus nose of a person, drag as in air friction versus drag as in pull on the ground, or wing of a plane versus wing of a bird) than was used in the general corpus of data. These differences may be captured by tuning the token-based model using masked language modeling of the domain-specific content.

As another specific example, the domain-specific content may include information about troubleshooting various Windows® operating system errors that may include terminology that was not referenced in the general corpus of data that was used to pre-train the token-based model (e.g., netpath as a network path, printq as a printer queue, GUID for global user ID, hresult for result handle, procnum for procedure number, specific error codes, abbreviations, acronyms, or other domain-specific terminology), and/or may use terminology in a different way than was used in the general corpus of data (e.g., bug in software versus an insect bug, or a page occurring in a memory page fault versus a paper page of a notebook). These differences may be captured by tuning the token-based model using masked language modeling of the domain-specific content.

The masked language model receives the pre-trained token-based model as well as the domain-specific content as inputs. The masked language model tokenizes the domain-specific content, tunes the pre-trained token-based model, and generates a tuned version of the pre-trained token-based model that has been tuned on the domain-specific content. Using the masked language model, the token-based model is tuned to predict tokens that have been removed from a tuning version of the domain-specific content. In other words, the masked language model is used to analyze masked and potentially ambiguous tokens in the domain-specific content and the rest of the words in same sentences or chunks of domain-specific content to predict a specific word meaning in place of the masked word, to improve the token-based model's ability to disambiguate the token once the token-based model is tuned based on correct and incorrect predictions.

In a specific example, the masked language model may mask the term “animal” in the text chunk “A jaguar is an animal that lives in the zoo,” which may occur in the domain-specific content, and the masked language model may use the token-based model to predict the token that should be in the masked portion of the text chunk “A jaguar is an [MASK] that lives in the zoo” based on the surrounding tokens in the text chunk. The MLM may improve the token-based model by increasing the confidence for predicting “animal” for the masked portion that occurs with “jaguar,” “lives,” and “zoo,” for example, and decreasing the confidence for predicting “car” in this scenario even if it was previously learned that “jaguar” sometimes occurs with “car”. In the example, the masked language model may provide negative feedback to the token-based model for an incorrect prediction, decreasing weights of factors previously relied upon by the token-based model, and positive feedback to the token-based model for a correct prediction, reinforcing or potentially increasing weights of factors previously relied upon by the token-based model.

In the example, the token-based model may receive the most negative feedback based on terms that were missing from the general corpus of data used to train the token-based model, or were used differently in the general corpus of data used to train the token-based model. For terms that are used in a similar way in the domain-specific content, the token-based model may already be likely to correctly predict words masked by the masked language model. For the new terms or terms that are used in different ways than the general corpus of data, the masked language model provides a mechanism to improve the token-based model at predicting those new or differently used terms.

Referring back to FIG. 1, once a machine learning model such as a token-based model is trained, a masked language model is used in block 104 to tune the machine learning model on different content from that which the machine learning model was trained. The machine learning model as tuned may then be used for determining term-to-term similarity and, in turn, chunk-to-chunk similarity for tuning a text similarity model.

Referring back to FIGS. 2A and 2B, once token-based model has been trained, masked language model 208 uses a domain-specific corpus of data to tune token-based model 206, resulting in tuned token-based model 212. As shown in FIG. 2A, domain-specific corpus of data 210A is used by masked language model 208 for tuning, and domain-specific corpus of data 210A may be separate from domain-specific corpus of data 216A, which is used to create token-embeddings 222 and 224 for separate chunks of content 218 and 220. As shown in FIG. 2B, Domain-specific corpus of data 216B is used by masked language model 208 to tune token-based model 206, resulting in tuned token-based model 212. Domain-specific corpus of data 216B may also be used to create token-embeddings 222 and 224 for separate chunks of content 218 and 220. In other embodiments (not separately illustrated), some data of domain-specific corpus of data 216A may overlap with some data of domain-specific corpus of data 210A, and some data may not overlap.

In one embodiment, tuning by the masked language model causes new words to be added to a dictionary of the token-based model along with probabilities that the new words appear with other words, providing a contextual probabilistic background of how the new words are used with other words. The contextual probabilistic background may be used to predict the new word in a masked position in a next iteration of using the masked language model, either for further tuning of the token-based model or for testing the accuracy of the tuned token-based model.

In a specific example for domain-specific content relating to Windows® error codes, a specific term such as hresult may be detected as frequently used in the domain-specific content and missing from the token-based model. The specific term may be added to a dictionary of the token-based model along with probabilities that the term occurs before or after other terms. For example, the hresult term may be detected to frequently occur after “exception” and before “contact” and “support,” such as in “An attempt was made to load a program with an incorrect format. (Exception from HRESULT: 0x80070008). Please reinstall the product or contact support” and “Module
C:\WINDOWS\system32\WiXSetup\SampleIMEx64.dll failed to register. HRESULT—2147024770. Contact your support personnel.”

Once the token-based model has been tuned with the masked language model using at least a portion of domain-specific content, the tuned token-based model may be tested for accuracy using, for example, another portion of the domain-specific content. The tuned token-based model may include adjusted embeddings and new terms based on the domain-specific content, and the tuned token-based model may be tested to verify that the tuned model performs better than the untuned or otherwise previously tuned token-based model, and/or that the tuned token-based model performs with better than a threshold level of accuracy. If the tuned token-based model is accurate as tuned at predicting words for the other portion of the domain-specific content, for example, by having an accuracy score above a threshold value, the tuned token-based model may pass the tuning and testing phase to be used in determining pairs of similar sentences as described in more detail herein.

### Determining Chunk-to-Chunk Similarity Based on Token-to-Token Similarity for Domain-Specific Chunks of Text

In one embodiment, a sentence, paragraph, or other text similarity model may be trained in an unsupervised way by taking as input paraphrases that have been automatically determined to be similar. The paraphrases may be mined using a technique based on ColBERT. ColBERT is a technique for transforming each token from a query and from a target document into a word embedding. Afterwards, for each word in the query, a cosine similarity is determined word-to-word between words in the query and words in a target document to pick maximally similar words. The overall score between the query and the document is computed by summing, averaging, or otherwise aggregating the scores associated with each word. In one embodiment, instead of performing the ColBERT technique between a query and a paragraph in a document, the ColBERT technique is performed between two paragraphs or other chunks of domain-specific content to determine word-to-word similarities and an average word-to-word similarity between the two paragraphs or other chunks of domain-specific content.

A corpus of content, such as the domain-specific that was used by the masked language model to tune the token-based model or other domain-specific or custom content, may be split into paragraphs to determine which paragraphs are similar to each other. The corpus of content may include a set of documents or other chunks of text such as text about a specific topic or domain or otherwise text that is unique or different from the text used to train the token-based model. Using a ColBERT technique, the embeddings are determined for each word in the paragraph or other chunk of words using the tuned token-based model, and a similarity, for example, based on a cosine similarity, is determined for the embeddings of each word or token in the first paragraph or first chunk of words with the embeddings of each word or token in the second paragraph or second chunk of words. For embeddings of each word or token in the first paragraph or first chunk of words, a maximum similarity or maximum cosine similarity is determined among embeddings of the words or tokens in the second paragraph or second chunk of words. The embeddings are produced from the fine-tuned token-based model that has been tuned on domain-specific content.

Referring back to FIG. 1, process 100 continues in block 106 to use the machine learning model as tuned to determine vector embeddings for terms in chunks of content. Then, for each term in a chunk of content, block 108 includes finding a term in another chunk of content having a highest similarity score with the term. For example, the similarity scores may be determined using cosine similarity based on the vector embeddings determined in block 106. An aggregate similarity score between the chunks of content is determined in block 110 based on the term-to-term similarity scores determined in block 108. The aggregate similarity score for a pair of chunks may be used to determine whether the chunks are similar, dissimilar, or neither similar nor dissimilar, and a text similarity model may be trained accordingly.

Referring back to FIGS. 2A and 2B, model management system 202 may select domain-specific chunks 218 and 220 from domain-specific corpus of data 216A or 216B, and these chunks 218 and 22 may be used by tuned token-based model 214 to create token-embeddings 222 and 224 for each chunk. For example, token-embeddings 222 may correspond to the individual terms in domain-specific chunk 218, and token-embeddings 224 may correspond to the individual terms in domain-specific chunk 220. Maximum token-to-token similarities for tokens 226 may be determined between domain-specific chunk 218 and domain-specific chunk 220 based on the token-embeddings for each chunk 222 and 224. The maximum token-to-token similarities 226 may then be aggregated to generate an aggregate chunk similarity 228, which can be applied to chunk similarity policies 230. Chunk similarity policies may include one or more conditions such as upper thresholds, lower thresholds, relative thresholds, or absolute thresholds, for determine whether to mark the chunks as similar or dissimilar. Iteratively applying aggregate chunk similarity 228 for different pairs of chunks to chunk similarity policies 230 results in similar chunk(s) 232 and/or dissimilar chunk(s) 234. Observed similarities between chunks may be used to train a text similarity model for matching similar text.

In one embodiment, the ColBERT technique may process the domain-specific content in phases. In a first phase, paragraphs or chunks of the domain-specific content are separated, such that domain specific content D=P₁, P₂, P₃, P₄, P₅, . . . , P_{N} for different paragraphs or chunks of content P_{N}. In a second phase, the tuned token-based model is used to determine embeddings for each word in each of the given paragraphs or chunks of domain-specific content, such that P_{N}=w₁, w₂, w₃, w₄, w₅, . . . w_{M} for different word embeddings w_{M} for M word embeddings in P_{N}. In a third phase, each of i word embeddings in a given paragraph, P_{X}=w_{X1}, w_{X2}, w_{X3}, w_{X4}, w_{X5}, . . . w_{Xi}, may be compared to each other word embedding of each other paragraph or chunk (or specific other paragraphs or chunks) P_{Y}=w_{Y1}, w_{Y2}, w_{Y3}, w_{Y4}, w_{Y5}, . . . to determine a maximally similar word embedding within each of the other paragraphs or chunks, such as a word embedding with maximal cosine similarity among the terms in the other paragraph or chunk. For example, for w_{Xi} in P_{X}, the maximally similar word embedding in P_{Y} may be w_{Yj}. These similar word pairings may be referred to as w_{Xi}=w_{S1} and w_{Yj}=w_{S2} for any maximally similar word pairing (w_{S1}, w_{S2}). The cosine similarity between w_{S1} and w_{S2} may be expressed as the dot product of the vectors divided by the product of the lengths of the vectors,

$$\frac{{W}_{S 1} \cdot {W}_{S 2}}{\vert {W}_{S 1} \vert * \vert {W}_{S 2} \vert} .$$

Although cosine similarities may be determined between W_{X1} (W_{S1}) and all words in P_{Y}, the selected maximally similar word W_{S2} has the highest similarity score for the given word. Even if the same word exists in P_{Y}, because the vector embedding includes a context of surrounding words and meanings of the surrounding words, the same word is not necessarily the word with maximal similarity to the given word if the word is used in a completely different context. For example, if P₁=“A jaguar ran at the car we were driving” and P₂=“A cat ran at the jaguar we were driving,” the word “jaguar” in P1 would have a highest similarity score with the word “cat” in P₂, not to “jaguar” in P₂, and the word “car” in P₁ would have a highest similarity score to the word “jaguar” in P₂.

The third phase may involve iterating through each word of each given paragraph or chunk P_{N} to find a maximally similar word embedding for the word in each other paragraph or chunk P₁, P₂, P₃, P₄, P₅, . . . P_{N-1}. In a fourth phase, for each word (W_{S1}) in a given paragraph P_{X}, a similarity score of a maximally similar word (W_{S2}) in a specific other paragraph P_{Y} is aggregated to generate an aggregated similarity score between the given paragraph and the specific other paragraph. For example, the similarity scores of the maximally similar corresponding words in the specific other paragraph may be summed together and divided by the total number of words in the given paragraph to determine an average word-by-word similarity of the words in the given paragraph to the words in the specific other paragraph. The fourth phase may involve iterating through each word of each given paragraph or chunk to aggregate the similarity scores to generate aggregate similarity scores for each pair of paragraphs or chunks.

In various embodiments, subsets or samples of paragraphs or chunks of text may be selected to determine similarities between pairs of paragraphs or chunks of text in the subset or sample. In various embodiments, in addition to or instead of determining aggregate similarity scores in a phased approach, the ColBERT technique determines aggregate similarity scores using parallel processing on a paragraph-by-paragraph or chunk-by-chunk basis where different worker threads handle different subsets of paragraphs or chunks.

The ColBERT technique receives the fine-tuned token-based model and the paragraphs from the custom content as input, and the ColBERT technique generates pairs of sentences or paragraphs and similarity scores between the sentences or paragraphs in the pairs. Once the maximum token-to-token similarities are determined between paragraphs or other chunks of text, the average or other aggregate combination of the maximally similar tokens is determined as the similarity between the first paragraph and the second paragraph. For example, two words that are similar may have a cosine similarity of the word embeddings close to 1, and two words that are dissimilar may have a cosine similarity of the word embeddings close to 0. Accordingly, two paragraphs, sentences, social media posts, blog posts, articles, queries, and/or other chunks of text that are similar may have an average maximal similarity between words close to 1, and two paragraphs, sentences, social media posts, blog posts, articles, queries, and/or other chunks of text that are dissimilar may have an average maximal similarity between words close to 0. The resulting pairs of paragraphs may each have associated similarity scores.

In another embodiment, in addition to or instead of using the ColBERT technique, the system may use other techniques for determining the similarity between a first set of vector embeddings and a second set of vector embeddings for different pairs of sets of vector embeddings. In one example, the system compresses each set of vector embeddings using principal component analysis (PCA) to approximate N-dimensions of vector embeddings to M-dimensions of vector embeddings by preserving parts of the chunks that vary most from other paragraphs or chunks of the domain-specific content. The reduced embedding of a paragraph may provide a summary of the paragraph as the paragraph differs from other paragraphs in the domain-specific content. For example, the reduced embeddings may cover fewer words, such as eliminating or reducing the impact of words that are common to many paragraphs in the domain-specific content, and/or may cover fewer aspects of metrics or measurements about the words. Then, the reduced embeddings in M-dimensions may be compared to each other to find other sentences with similar vector embeddings along the reduced dimensions.

In one embodiment, once the content has been split into paragraphs and embeddings are generated for each token of each paragraph, an index may be used to find sets of vectors that are similar to each other. In one example, FAISS is used as an index to find paragraph sets of vector embeddings that are similar to each other. FAISS is a library available on GitHub used for determining vector-to-vector similarity. FAISS indexes similar vectors so they can be searched without having to compute a similarity between each pair of paragraphs.

In the same or another embodiment, once a given paragraph has been determined to be similar to a particular other paragraph, the system may look up the particular other paragraph in an index to find other paragraphs that are already marked as similar to the particular other paragraph. These similar other paragraphs may be compared with the given paragraph to determine if any of the other paragraphs are also similar to the given paragraph. In another embodiment, rather than performing a similarity measurement for each of the other paragraphs, all of the other paragraphs may be marked as similar based on the determination that the other paragraphs are already similar to the particular other paragraph.

In the same or another embodiment, once a given paragraph has been determined to be dissimilar to a particular other paragraph, the system may look up the particular other paragraph in an index to find other paragraphs that are already marked as similar to the particular other paragraph. These similar other paragraphs may be compared with the given paragraph to determine if any of the other paragraphs are also dissimilar to the given paragraph. In another embodiment, rather than performing a similarity measurement for each of the other paragraphs, all of the other paragraphs may be marked as dissimilar based on the determination that the other paragraphs are already similar to the particular other paragraph, which is dissimilar to the given paragraph.

In yet another embodiment, the sets of vector embeddings corresponding to the paragraphs of domain-specific content may be input into a clustering algorithm that provides a high-level clustering of sets of vector embeddings based on shared features. For example, such clustering may result in splitting a Windows® error codes document corpus into documents specific to different groups of error codes. A more precise similarity determination may then be determined for each pair of paragraphs within a same cluster, for example, using the ColBERT technique or another technique on a reduced set of paragraph pairs.

Paragraph similarity comparison techniques may be combined together, for example, with some lower-cost similarity approximations occurring first and higher-cost similarity measurements occurring for those paragraphs that are determined to be the most or least similar based on the similarity approximations, and/or for those paragraphs not known by the approximation to be dissimilar or similar, to disambiguate whether paragraphs not known to be dissimilar or similar are actually dissimilar or similar with the higher-cost similarity measurement. For example, paragraphs with nearly exactly the same language (e.g., greater than a threshold percentage of words are the same or all words but articles and connecting words are the same) may be marked as similar without a finer-grained similarity measurement.

### Training a Text Similarity Model Based on the Chunk-to-Chunk Similarity

The tuned model, term by term and chunk of text by chunk of text, is used to determine whether two paragraphs, sentences, social media posts, blog posts, articles, queries, and/or other chunks of text are similar or dissimilar. Similarity or dissimilarity may be represented by an aggregate similarity score determined between the two paragraphs, sentences, social media posts, blog posts, articles, queries, and/or other chunks of text, or based on a determination of whether the similarity score exceeds a threshold, such as a lower threshold score of-0.9 and an upper threshold score of 0.9. For example, if the similarity exceeds the upper threshold, the chunks of text may be marked as similar, and if the similarity is below the lower threshold, the chunks of text may be marked as dissimilar. Use of the tuned model to determine similarity or dissimilarity between sentences or chunks of text may result in an automatically determined annotation for the pairs of sentences or pairs of other chunks of text. The annotation may signal that the pairs are similar (e.g., have high aggregate similarity scores) or dissimilar (e.g., have low aggregate similarity scores), for example. For example, pairs with aggregate similarity scores above an absolute or relative threshold or percentile similar may be marked, via an annotation or other metadata, as similar, and pairs with aggregate similarity scores below an absolute or relative threshold or percentile similar may be marked as dissimilar.

The pair of paragraphs, sentences, social media posts, blog posts, articles, queries, and/or other chunks of text, along with the annotation of similar or dissimilar for the pair, may be input into the paragraph or sentence model or other text similarity model as unsupervised ground truth labels to train the paragraph or sentence model with pairs of text that are similar or dissimilar. For example, the ground truth labels may be input into a base sentence model such as sentence-transformers_all-MiniLM-L12-v2 and used to fine-tune the base sentence model to account for the domain-specific data. The text similarity model may then improve at detecting similar and dissimilar paragraphs, sentences, social media posts, blog posts, articles, queries, and/or other chunks of text based on the annotations, which are based on domain-specific data. These improvements can be attained based on the automatic processing of domain-specific paragraphs using the techniques described herein, without supervision from an expert on which paragraphs are actually similar to each other.

Referring back to FIG. 1, process 100 continues in block 112 to determine whether the aggregate similarity score for a pair of chunks is greater than a first threshold or less than a second threshold. If the aggregate similarity score is less than the second threshold, in block 114, the pair may be marked as dissimilar, and, in block 120, a text similarity model may be trained to identify the pair as dissimilar. If the aggregate similarity score is greater than the first threshold, in block 116, the pair may be marked as similar, and, in block 122, a text similarity model may be trained to identify the pair as similar. If the aggregate similarity score does not satisfy any of the conditions for marking the pair as similar or dissimilar or training the text similarity model accordingly, block 118 of process 100 avoids marking the pair as similar or dissimilar. As shown, this portion of process 100 ends, but process 100 may continue to use the text similarity model as tuned to determine a similarity of dissimilarity between chunks of text.

Referring back to FIGS. 2A and 2B, similar chunk(s) 232 and/or dissimilar chunk(s) 234 are determined from pairs of chunks for which aggregate chunk similarities were evaluated by chunk policies 230. Similar chunk(s) 232 and/or dissimilar chunk(s) 234 may be provided as ground truth labels to tune text similarity model 236. Text similarity model may then be used to indicate similar or dissimilar text based on known or unknown inputs.

### Using the Text Similarity Model to Determine a Similarity Between Chunks of Text

The sentence or paragraph model or other text similarity model is trained based on ground truth labels that may include labels determined in an unsupervised manner as described herein. The text similarity model may be used to perform a semantic search by translating a query into a vector embedding and determining which paragraphs that occur in a candidate result set best match the query based on which paragraphs are determined by the text similarity model to be most similar to the query. The text similarity model as trained may find vector embeddings of the paragraphs most closely matching the vector embedding of the query and provide a content document containing the most closely matching paragraphs as a result to the query, optionally with the most closely matching paragraphs highlighted separately or as part of the content document in search result text.

In one example, a user interface of a web site receives the search query from a user, and the search query is reduced to vector embeddings using a text embedding model. The vector embedding of the query may then be passed into the text similarity model to determine other paragraphs with vector embeddings that are similar to, or have a high cosine similarity score with, the vector embedding of the query. The resulting paragraphs may be sorted or filtered based on similarity or any other characteristic, and additional feedback may be provided to the text similarity model based on which content document containing which similar paragraph is selected and viewed by the user, with paragraphs from unselected content documents optionally receiving negative similarity feedback.

In various embodiments, the techniques described herein may be used to generate embeddings for a sentence, a paragraph, a social media post, a blog post, and article, a query, and/or any other chunk of text. The embeddings may be used to determine if two paragraphs, sentences, social media posts, blog posts, articles, queries, and/or other chunks of text are similar or dissimilar, for example, using a cosine similarity between the two paragraphs, sentences, social media posts, blog posts, articles, queries, and/or other chunks of text. The similar or dissimilar chunks of text may be input into a text similarity model during a tuning phase to more efficiently determine similar sentences in a production phase of the text similarity model. During the production phase of the text similarity model, the text similarity model may be used to support query evaluation to find similar documents, to support clustering groups of similar documents together, to support merging content or documents together, or otherwise provide, display, or send an indication that one text chunk is similar to another text chunk or that a pair or group of text chunks are similar.

Referring back to FIGS. 2A and 2B, similar chunk(s) 232 and/or dissimilar chunk(s) 234 may be used to tune text similarity model 236. Text similarity model may then be used to match an input query from query interface 204 with candidate search results, and the closest matching candidate search results may be provided to a user via query interface 204.

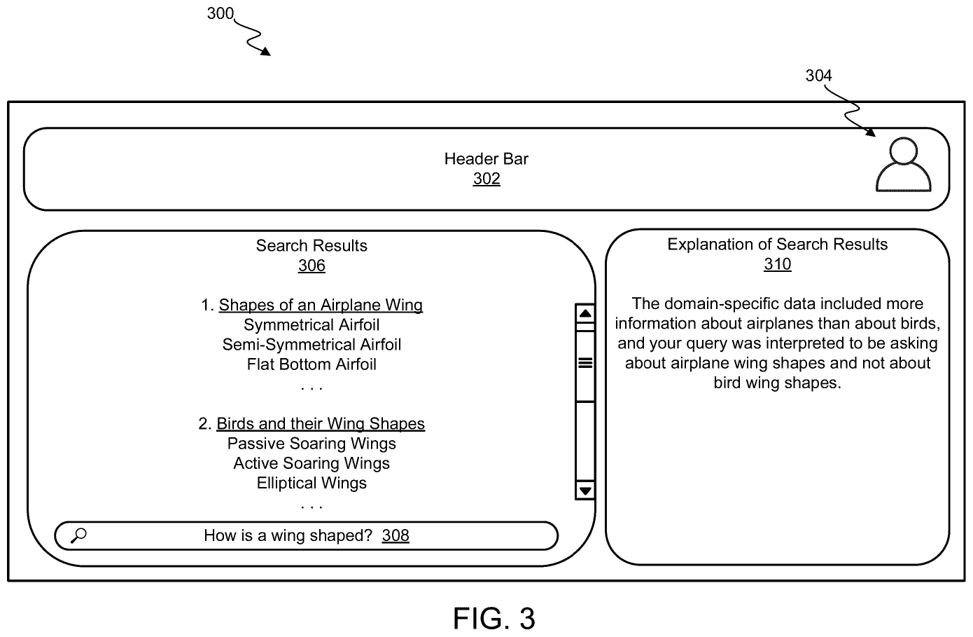

FIG. 3 illustrates a diagram of an example user interface 300 for displaying search results 306 that match chunks of text similar to a query 308. As shown, user interface 300 includes a header bar 302 and an indication of a logged in user 304. Search results 306 may be produced based on query 308 using a text similarity model that was tuned on domain-specific data. The text similarity model may be tuned globally for all users, for a tenancy of users or any other group of users, or for individual users such as the logged in user 304. User interface 300 may also include an explanation of search results 310, which explains why the search results are appearing in the order shown or with the corresponding ranking applied. In the example, query 308 is for “How is a wing shaped?”, and this query best matches a content item with a header “Shapes of an Airplane Wing” based on domain-specific tuning of the text similarity model. The query also matches a content item “Birds and their Wing Shapes.” The explanation of search results 310 section explains “The domain-specific data included more information about airplanes than about birds, and your query was interpreted to be asking about airplane wing shapes and not about bird wing shapes.” Explanation 310 helps user 304 understand that the tuning on domain-specific data was effective. Also, the order or rank and/or quality of search results helps user 304 understand that the tuning was effective.

### Computer System Architecture

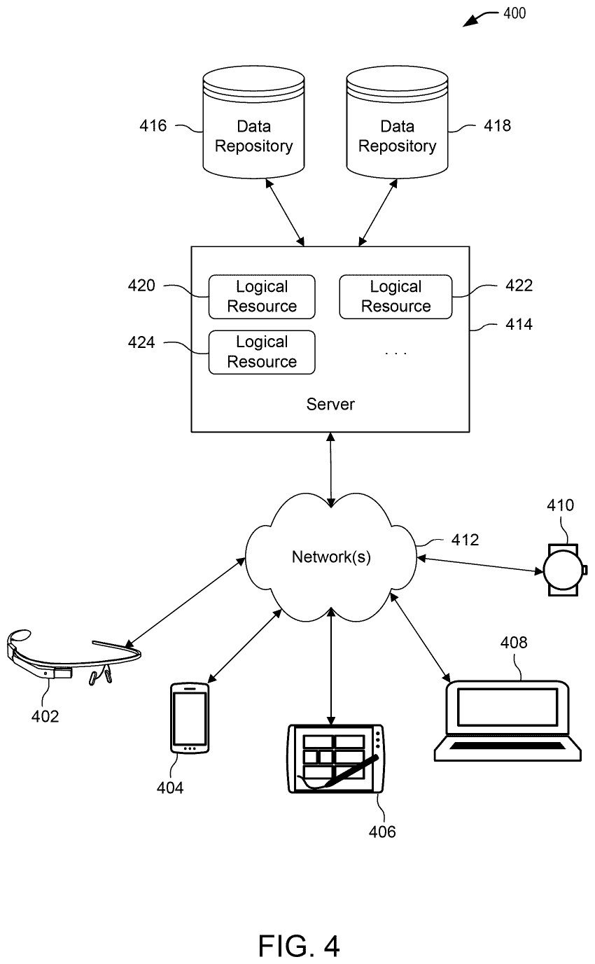

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for identifying similar chunks of text to tune a text similarity model.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for identifying similar chunks of text to tune a text similarity model in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android™, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation system, Nintendo Switch™, and other devices), and the like. The client devices may be capable of executing various different applications such as various Internet-related apps, communication applications (e.g., e-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks.

Server 414 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for identifying similar chunks of text to tune a text similarity model. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

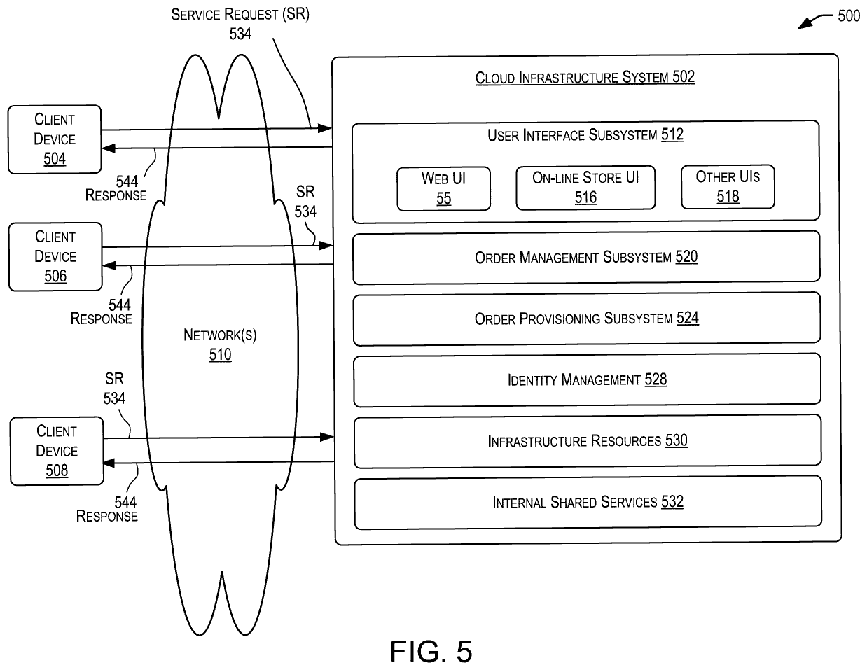

FIG. 5 is a simplified block diagram of a cloud-based system environment in which identifying similar chunks of text to tune a text similarity model, in accordance with certain aspects. In the embodiment depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 412. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The embodiment depicted in FIG. 5 is only one example of a cloud infrastructure system and is not intended to be limiting. It should be appreciated that, in some other aspects, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative aspects.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 502. Cloud infrastructure system 502 then performs processing to provide the services requested in the tenant's subscription order. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public tenant, where the tenant can be an individual or an enterprise. In certain other aspects, under a private cloud model, cloud infrastructure system 502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 502 and the services provided may be shared by several organizations in a related community. Various other models such as hybrids of the above mentioned models may also be used.

Client computing devices 504, 506, and 508 may be of different types (such as devices 402, 404, 406, and 408 depicted in FIG. 4) and may be capable of operating one or more client applications. A user may use a client device to interact with cloud infrastructure system 502, such as to request a service provided by cloud infrastructure system 502.

In some aspects, the processing performed by cloud infrastructure system 502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like.

In certain aspects, to facilitate efficient provisioning of these resources for supporting the various cloud services provided by cloud infrastructure system 502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a tenant may, using a client device, request (service request 534) one or more services provided by cloud infrastructure system 502 using one or more of interfaces 514, 516, and 518. For example, a tenant may access the online store, browse cloud services offered by cloud infrastructure system 502, and place a subscription order for one or more services offered by cloud infrastructure system 502 that the tenant wishes to subscribe to. The service request may include information identifying the tenant and one or more services that the tenant desires to subscribe to.

In certain aspects, such as the embodiment depicted in FIG. 5, cloud infrastructure system 502 may comprise an order management subsystem (OMS) 520 that is configured to process the new order. As part of this processing, OMS 520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 520 may then invoke the order provisioning subsystem (OPS) 524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 502 may send a response or notification 544 to the requesting tenant to indicate when the requested service is now ready for use. In some instances, information (e.g., a link) may be sent to the tenant that enables the tenant to start using and availing the benefits of the requested services.

Cloud infrastructure system 502 may provide services to multiple tenants. For each tenant, cloud infrastructure system 502 is responsible for managing information related to one or more subscription orders received from the tenant, maintaining tenant data related to the orders, and providing the requested services to the tenant or clients of the tenant. Cloud infrastructure system 502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 502 may provide services to multiple tenants in parallel. Cloud infrastructure system 502 may store information for these tenants, including possibly proprietary information. In certain aspects, cloud infrastructure system 502 comprises an identity management subsystem (IMS) 528 that is configured to manage tenant's information and provide the separation of the managed information such that information related to one tenant is not accessible by another tenant. IMS 528 may be configured to provide various security-related services such as identity services, such as information access management, authentication and authorization services, services for managing tenant identities and roles and related capabilities, and the like.

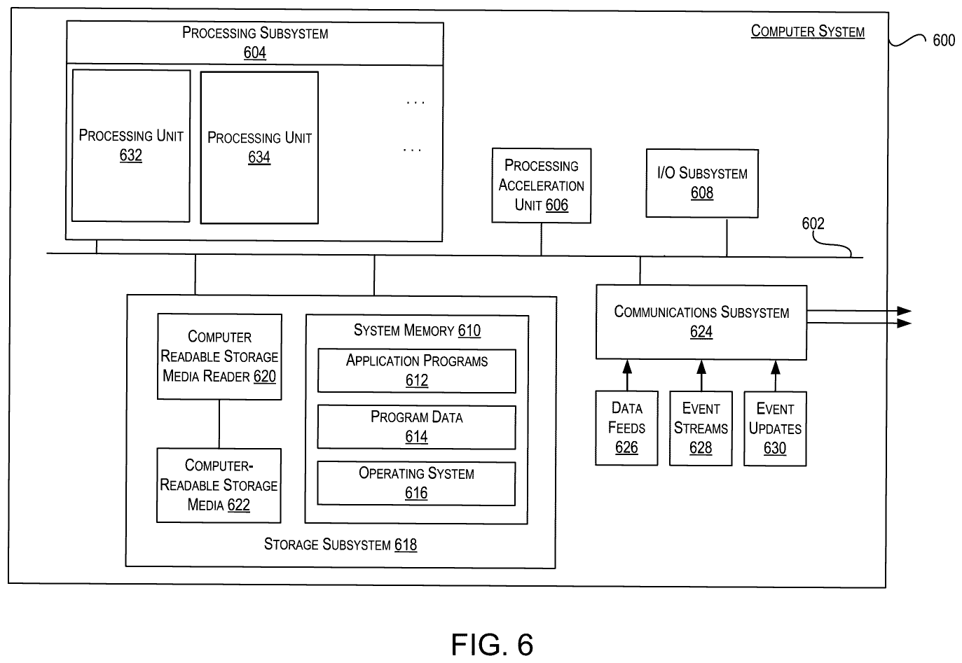

FIG. 6 illustrates an exemplary computer system 600 that may be used to implement certain aspects. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may include be single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the program code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android™ OS, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices.

Communication subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communication subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
using a masked language model to tune a machine learning model on a corpus of content different than another corpus of content on which the machine learning model was previously trained, wherein using the masked language model to tune the machine learning model causes additional terms to be added to a dictionary of the machine learning model; and wherein the corpus of content includes the additional terms;
using the machine learning model as tuned to determine a plurality of vector embeddings for a plurality of terms in a plurality of chunks of content from a particular corpus of content that is different than the other corpus of content on which the machine learning model was previously trained; wherein the plurality of chunks of content comprises a first chunk, a second chunk, and a third chunk; wherein the first chunk comprises a first plurality of terms, the second chunk comprises a second plurality of terms, and the third chunk comprises a third plurality of terms;
determining a first vector embedding for a first term having a highest similarity score, among the second plurality of terms, with a particular vector embedding of a particular term of the first plurality of terms;
determining a second vector embedding for a second term having a highest similarity score, among the third plurality of terms, with the particular vector embedding of the particular term of the first plurality of terms;
determining a third vector embedding for a third term having a highest similarity score, among the second plurality of terms, with another particular vector embedding of another particular term of the first plurality of terms;
determining a fourth vector embedding for a fourth term having a highest similarity score, among the third plurality of terms, with the other particular vector embedding of the other particular term of the first plurality of terms;
determining a first aggregate similarity score between the first chunk and the second chunk based at least in part on similarity scores between:
the particular term and the first term, and
the other particular term and the third term;
determining a second aggregate similarity score between the first chunk and the third chunk based at least in part on similarity scores between:
the particular term and the second term, and
the other particular term and the fourth term;
based at least in part on determining that the first aggregate similarity score satisfies one or more conditions, storing an indication that the first chunk is similar to the second chunk; wherein the second aggregate similarity score does not satisfy the one or more conditions;
tuning a text similarity model to identify similar texts by providing, to the text similarity model, the indication;
using the text similarity model to identify content in response to a query.

2. The computer-implemented method of claim 1, wherein using the masked language model to tune the machine learning model comprises masking terms in the other corpus of content, receiving predictions of the machine learning model for the masked terms, and providing feedback to the machine learning model on accuracies of the predictions.

3. The computer-implemented method of claim 1, wherein a first similarity score between the first vector embedding and the particular vector embedding, a second similarity score between the second vector embedding and the particular vector embedding, a third similarity score between the third vector embedding and the other particular vector embedding, and a fourth similarity score between the fourth vector embedding and the other particular vector embedding are each determined based at least in part on cosine similarity.

4. The computer-implemented method of claim 1, wherein the machine learning model comprises a Bidirectional Encoder Representations from Transforms (BERT)-based uncased token-based model.

5. The computer-implemented method of claim 1, wherein the other corpus of content consists of publicly available text sources, and wherein the corpus of content comprises domain-specific text sources from an access-restricted private database.

6. The computer-implemented method of claim 1, wherein determining the first aggregate similarity score between the first chunk and the second chunk comprises averaging similarity scores between terms in the first chunk and terms in the second chunk, and wherein determining the second aggregate similarity score between the first chunk and the third chunk comprises averaging similarity scores between terms in the first chunk and terms in the third chunk.

7. The computer-implemented method of claim 1, further comprising accessing an index of similar chunks to determine that the second chunk is similar to a fourth chunk, and, based at least in part on the index:
storing another indication that the first chunk is similar to the fourth chunk, and
tuning the text similarity model to identify similar texts by providing, to the text similarity model, the other indication.

8. The computer-implemented method of claim 1, wherein the one or more conditions comprise a similarity threshold, and wherein the text similarity model is not tuned with an indication that the first chunk is similar to the third chunk.

9. The computer-implemented method of claim 1, wherein the one or more conditions comprise a similarity threshold, the computer-implemented method further comprising:
based at least in part on determining that the second aggregate similarity score satisfies one or more other conditions, storing another indication that the first chunk is dissimilar to the third chunk; wherein the first aggregate similarity score does not satisfy the one or more other conditions; and
tuning the text similarity model to identify dissimilar texts by providing, to the text similarity model, the other indication.

10. The computer-implemented method of claim 1, wherein the query is a natural language query, the computer-implemented method further comprising:
receiving, via a user interface, the query;
wherein using the text similarity model to identify content in response to the query comprises:
using the text similarity model, ranking two or more candidate results of a plurality of candidate results to the query based on how similar text in the two or more candidate results are to the query;
based at least in part on the ranking, causing display of a reference to at least one of the two or more candidate results of the plurality of candidate results to the query.

11. A computer-program product comprising one or more non-transitory machine-readable storage media, including stored instructions configured to cause a computing system to perform a set of actions including:
using a masked language model to tune a machine learning model on a corpus of content different than another corpus of content on which the machine learning model was previously trained, wherein using the masked language model to tune the machine learning model causes additional terms to be added to a dictionary of the machine learning model; and wherein the corpus of content includes the additional terms;
using the machine learning model as tuned to determine a plurality of vector embeddings for a plurality of terms in a plurality of chunks of content from a particular corpus of content that is different than the other corpus of content on which the machine learning model was previously trained; wherein the plurality of chunks of content comprises a first chunk, a second chunk, and a third chunk; wherein the first chunk comprises a first plurality of terms, the second chunk comprises a second plurality of terms, and the third chunk comprises a third plurality of terms;
determining a first vector embedding for a first term having a highest similarity score, among the second plurality of terms, with a particular vector embedding of a particular term of the first plurality of terms;
determining a second vector embedding for a second term having a highest similarity score, among the third plurality of terms, with the particular vector embedding of the particular term of the first plurality of terms;
determining a third vector embedding for a third term having a highest similarity score, among the second plurality of terms, with another particular vector embedding of another particular term of the first plurality of terms;
determining a fourth vector embedding for a fourth term having a highest similarity score, among the third plurality of terms, with the other particular vector embedding of the other particular term of the first plurality of terms;
determining a first aggregate similarity score between the first chunk and the second chunk based at least in part on similarity scores between:
the particular term and the first term, and
the other particular term and the third term;
determining a second aggregate similarity score between the first chunk and the third chunk based at least in part on similarity scores between:
the particular term and the second term, and
the other particular term and the fourth term;
based at least in part on determining that the first aggregate similarity score satisfies one or more conditions, storing an indication that the first chunk is similar to the second chunk; wherein the second aggregate similarity score does not satisfy the one or more conditions;
tuning a text similarity model to identify similar texts by providing, to the text similarity model, the indication;
using the text similarity model to identify content in response to a query.

12. The computer-program product of claim 11, wherein a first similarity score between the first vector embedding and the particular vector embedding, a second similarity score between the second vector embedding and the particular vector embedding, a third similarity score between the third vector embedding and the other particular vector embedding, and a fourth similarity score between the fourth vector embedding and the other particular vector embedding are each determined based at least in part on cosine similarity.

13. The computer-program product of claim 11, wherein determining the first aggregate similarity score between the first chunk and the second chunk comprises averaging similarity scores between terms in the first chunk and terms in the second chunk, and wherein determining the second aggregate similarity score between the first chunk and the third chunk comprises averaging similarity scores between terms in the first chunk and terms in the third chunk.

14. The computer-program product of claim 11, wherein the set of actions further includes accessing an index of similar chunks to determine that the second chunk is similar to a fourth chunk, and, based at least in part on the index:
storing another indication that the first chunk is similar to the fourth chunk, and
tuning the text similarity model to identify similar texts by providing, to the text similarity model, the other indication.

15. The computer-program product of claim 11, wherein the one or more conditions comprise a similarity threshold, and wherein the set of actions further includes:
based at least in part on determining that the second aggregate similarity score satisfies one or more other conditions, storing another indication that the first chunk is dissimilar to the third chunk; wherein the first aggregate similarity score does not satisfy the one or more other conditions; and
tuning the text similarity model to identify dissimilar texts by providing, to the text similarity model, the other indication.

16. A system comprising:
one or more processors;
one or more non-transitory computer-readable media storing instructions, which, when executed by the system, cause the system to perform a set of actions including:
using a masked language model to tune a machine learning model on a corpus of content different than another corpus of content on which the machine learning model was previously trained, wherein using the masked language model to tune the machine learning model causes additional terms to be added to a dictionary of the machine learning model; and wherein the corpus of content includes the additional terms;
using the machine learning model as tuned to determine a plurality of vector embeddings for a plurality of terms in a plurality of chunks of content from a particular corpus of content that is different than the other corpus of content on which the machine learning model was previously trained; wherein the plurality of chunks of content comprises a first chunk, a second chunk, and a third chunk; wherein the first chunk comprises a first plurality of terms, the second chunk comprises a second plurality of terms, and the third chunk comprises a third plurality of terms;
determining a first vector embedding for a first term having a highest similarity score, among the second plurality of terms, with a particular vector embedding of a particular term of the first plurality of terms;
determining a second vector embedding for a second term having a highest similarity score, among the third plurality of terms, with the particular vector embedding of the particular term of the first plurality of terms;
determining a third vector embedding for a third term having a highest similarity score, among the second plurality of terms, with another particular vector embedding of another particular term of the first plurality of terms;
determining a fourth vector embedding for a fourth term having a highest similarity score, among the third plurality of terms, with the other particular vector embedding of the other particular term of the first plurality of terms;
determining a first aggregate similarity score between the first chunk and the second chunk based at least in part on similarity scores between:
the particular term and the first term, and
the other particular term and the third term;
determining a second aggregate similarity score between the first chunk and the third chunk based at least in part on similarity scores between:
the particular term and the second term, and
the other particular term and the fourth term;
based at least in part on determining that the first aggregate similarity score satisfies one or more conditions, storing an indication that the first chunk is similar to the second chunk; wherein the second aggregate similarity score does not satisfy the one or more conditions;
tuning a text similarity model to identify similar texts by providing, to the text similarity model, the indication;
using the text similarity model to identify content in response to a query.

17. The system of claim 16, wherein a first similarity score between the first vector embedding and the particular vector embedding, a second similarity score between the second vector embedding and the particular vector embedding, a third similarity score between the third vector embedding and the other particular vector embedding, and a fourth similarity score between the fourth vector embedding and the other particular vector embedding are each determined based at least in part on cosine similarity.

18. The system of claim 16, wherein determining the first aggregate similarity score between the first chunk and the second chunk comprises averaging similarity scores between terms in the first chunk and terms in the second chunk, and wherein determining the second aggregate similarity score between the first chunk and the third chunk comprises averaging similarity scores between terms in the first chunk and terms in the third chunk.

19. The system of claim 16, wherein the set of actions further includes accessing an index of similar chunks to determine that the second chunk is similar to a fourth chunk, and, based at least in part on the index:
storing another indication that the first chunk is similar to the fourth chunk, and
tuning the text similarity model to identify similar texts by providing, to the text similarity model, the other indication.

20. The system of claim 16, wherein the one or more conditions comprise a similarity threshold, and wherein the set of actions further includes:
based at least in part on determining that the second aggregate similarity score satisfies one or more other conditions, storing another indication that the first chunk is dissimilar to the third chunk; wherein the first aggregate similarity score does not satisfy the one or more other conditions; and
tuning the text similarity model to identify dissimilar texts by providing, to the text similarity model, the other indication.
